(19) United States
(12) Patent Application Publication
(10) Pub. No.: US 2015/0372352 A1
(43) Pub. Date: Dec. 24, 2015

(54) ELECTROCHEMICAL CELLS

(71) Applicant: IONOTEC LIMITED, Runcorn Cheshire (GB)

(72) Inventors: Eric Frederick Waldron, Runcorn Cheshire (GB); Francis Michael Stackpool, Runcorn Cheshire (GB); Glyn Atherton, Widnes Cheshire (GB); Stephan Nicholas Heavens, Ludlow Shropshire (GB)

(21) Appl. No.: 14/764,240

(22) PCT Filed: Jan. 27, 2014
(86) PCT No.: PCT/GB2014/050197

§ 371 Date: Jul. 29, 2015

(30) Foreign Application Priority Data
Feb. 4, 2013 (GB) 1301952.6

(51) Int. Cl. H01M 10/39

(52) U.S. Cl. CPC H01M 10/399; H01M 2300/0074

(57) ABSTRACT

An electrochemical cell comprises a cathodic reactant, an anodic region containing liquid sodium, and a solid electrolyte separating the cathodic reactant from the liquid sodium in the anodic region. The anodic region is contained within the solid electrolyte. The cell further comprises a separate reservoir of liquid sodium the anodic region being supplied with liquid sodium from the reservoir. A metal plug is provided in the anodic region. The reservoir is not contained within the solid electrolyte.

This invention relates to electrochemical cells and in particular to such cells containing liquid sodium as the anodic material.

Storage of electrical energy represents a critical aspect of energy infrastructure development, particularly in the move away from fossil fuels towards less environmentally damaging sources of energy such as wind, solar power and electric vehicle traction. Sodium-sulphur (NaS) rechargeable battery cells present a potentially efficient and cost-effective means of electrical energy storage. Such electrochemical cells contain an ion-conductive solid electrolyte, typically sodium beta or beta″ alumina ceramic. The solid electrolyte separates the cathode reactant (sulphur) from an anodic region containing liquid sodium. Alternative cathode reactants to sulphur include nickel chloride and iron chloride as used in the sodium metal chloride or ‘Zebra’ battery cell. Other cathode materials have been investigated from time to time.

NaS is often the preferred chemical system for reasons of potentially low cost and high energy content. However the widespread adoption of NaS batteries is in part hampered by significant risk factors in regard to the potential for spontaneous battery fires with the release of toxic gas. This safety issue is sufficiently serious to the extent that the NaS battery is generally regarded as hazardous for electric vehicle application, but may be acceptable for stationary energy storage application with adequate safeguards. With all battery systems, problems concerning safety impinge on their cost-effectiveness because the need for containment of corrosive battery chemicals in the event of failures and the need for prevention of propagation of fires compromises battery performance in regard to the available energy and power for a given mass or volume of battery.

Sodium-sulphur battery safety problems frequently originate from an incidence of fracture of the highly brittle ceramic solid electrolyte, usually beta alumina, in a single battery cell. This is followed by exothermic chemical reaction between the electrode elements sodium (Na) and sulphur (S) to form sodium polysulphides (Na₂Sₓ). This in turn may be followed by leakage of Na₂Sₓ through the cell seals, breaching of the cell case, and further leakage through the rest of the battery. In severe cases heat generation caused by short-circuiting of cell interconnections can result in further propagation of the exothermic reaction throughout the battery.

Various systems have been devised for improving battery safety such as fuses and looping elements for isolating failed cells, but their use raises questions of the cost and the reliability of the safety device. It is preferable to address the issue of cell safety through the internal design of the battery cell itself.

The essence of an effective internal cell safety feature for cells containing liquid sodium as the anode material is the restriction of the supply of sodium in the event of failure of the ceramic solid electrolyte. Serious battery incidents generally occur when the cell is in or near the fully-charged state as in such circumstances the whole volume of sodium contained within the anode region is available for rapid exothermic reaction with sulphur. Restriction of the volume or mobility of liquid sodium contained within the anode results in much lower thermal excursions in the event of ceramic failure, and a consequently lower risk of a seal breach. At the same time, any means of restricting sodium mobility in the event of ceramic failure must not restrict sodium mobility in normal electrochemical cell operation; otherwise cell and battery performance will be compromised.

Various attempts have been made to restrict the amount of sodium available for rapid chemical reaction, while allowing the slow electrochemical reaction needed for normal cell operation. One method is to infill the anode region with an inert powder such as aluminium oxide (‘bauxilite’) or zirconium silicate (‘zircon sand’), as described in U.S. Pat. No. 4,396,588. For NaS cells of a tubular shape wherein the anode region lies within the solid electrolyte tube, the liquid sodium anode material is conventionally stored inside a tight fitting metal cartridge, otherwise referred to as a ‘safety can’, as described for example in U.S. Pat. No. 4,164,272. The safety can may be constructed from either steel or aluminium, and can also be provided with a surface coating of graphite to inhibit corrosion through the walls of the safety can from hot Na₂Sₓ in the event of solid electrolyte tube fracture. The disadvantage of containment of the liquid sodium within the solid electrolyte tube is that corrosion of the safety can results in the ready availability of sodium for chemical reaction with sulphur.

The infill approach as described above has the disadvantage that the infill powder contains around 35% natural voidage, so that when the cell is in the charged state the amount of sodium readily available within the pores remains high. The infill powder by itself is therefore not particularly effective in restricting sodium flow in the event of solid electrolyte fracture. Safety testing of NaS cells containing an infilled sodium anode region show only slight reduction in the incidence of cell breaching, which is quite inadequate for practical application.

In conjunction with infilling with inert powder, the inclusion of a hollow metal tube within the anode has been attempted. The intention of this approach has been for the metal tube to direct liquid sodium from the reservoir through the infilling towards the closed end of the solid electrolyte tube. Safety testing of cells containing this design of anode have not shown significant restriction on sodium flow in the event of ceramic failure.

The present invention has been made from a consideration of this.

According to the present invention there is provided an electrochemical cell comprising a cathodic reactant, an anodic region containing liquid sodium, and a solid electrolyte separating the cathodic reactant from the liquid sodium in the anodic region, the anodic region being contained within the solid electrolyte, the cell further comprising a separate reservoir of liquid sodium, the anodic region being supplied with liquid sodium from the reservoir, wherein, a metal plug is provided in the anodic region and said reservoir is not contained within the solid electrolyte.

The invention provides an improved means of restricting sodium flow in the event of solid electrolyte fracture that results in a very low occurrence of cell breaching and a consequently improved safety of operation of NaS batteries.

In one embodiment of the invention a separate external reservoir contains most of the liquid sodium, thereby separating the bulk of the sodium from the anode region that is contiguous with the ceramic solid electrolyte, said anode region containing a solid metal plug that conforms closely to the interior wall of the solid electrolyte. In the case of a cylindrical tubular solid electrolyte, the plug is a solid cylinder containing a central hole of small diameter, typically 2 mm, to allow inflow of sodium from the external reservoir. To inhibit sodium flow in the event of fracture of the solid electrolyte tube the annular gap between the metal cylinder and the solid electrolyte tube must be very small, preferably less than 0.5 mm, and more preferably less than 0.2 mm. The metal plug may be fabricated from steel or aluminium, or any metal that is compatible with liquid sodium and is solid at temperatures of up to 500° C. in order that it remains effective in preventing the flow of bulk sodium into the anode region in the event of an exothermic reaction due to fracture of the solid electrolyte. Moreover, allowance has to be made for the difference in thermal expansion behaviour between the solid electrolyte tube and the metal plug. If the metal plug is fabricated from aluminium, in order to facilitate machining to a close tolerance, the difference in thermal expansion coefficient between metal (25 ppm/° C.) and ceramic (7.5 ppm/° C.) is considerable.

In a further embodiment of the present invention, the plug provided in the anodic region may occupy at least 70%, 75%, 80%, 85%, 90% or 95% of the volume of the anodic region.

The fabrication of beta alumina solid electrolyte tubes with a close tolerance on internal diameter is very difficult, and machining of the ceramic tubes is costly. In accordance with a further embodiment of the present invention, the annular gap between metal plug and solid electrolyte is infilled with inert powder, for example zircon sand, in order to reduce the volume of sodium within the gap. In a further embodiment of the present invention, the annular gap between the metal plug and solid electrolyte contains in addition to the infill powder, a metal foil that acts as a wick for liquid sodium. The wick enables liquid sodium to rise by capillary action and thereby cover the whole of the inner surface of the solid electrolyte, promoting low cell resistance and high reliability. A suitable material for the metal foil is nickel, on which liquid sodium has a low contact angle and which has favourable wetting characteristics with liquid sodium.

In a further embodiment of the present invention, the metal foil has a rough surface and/or is of a corrugated form which assists wicking by liquid sodium.

In accordance with yet a further embodiment of the present invention, the annular gap between the metal plug and solid electrolyte contains, in addition to the infill powder, a multiplicity of foils. In addition to the above-mentioned foil wick, a springy foil is included which during the cell assembly process compresses the foil wick against the inner surface of the solid electrolyte, resulting in a small annular gap between the wick and the solid electrolyte, thereby increasing the effectiveness of the wick. The springy foil may be fabricated from a suitable metal such as steel. In addition to the metal foil wick and the springy metal foil, a further foil material may be included that is chemically resistant to Na₂Sₓ, for example a carbon-based material such as grafoil or Flexicarb. Inclusion of such a foil material helps to reduce corrosion of the metal plug in the event of chemical reaction caused by fracture of the solid electrolyte.

In a further embodiment of the present invention, the proportion of the surface area of the solid electrolyte in the anodic region in contact with liquid sodium may be at least 50%, 60%, 70%, 80%, 85%, 90%, 95% or may be 100%.

In accordance with yet a further embodiment of the present invention, the metal plug is fabricated from a low-melting material, for example aluminium, and is melted and refrozen during the cell assembly process. The melting step causes the metal plug to conform to the inner surface of the solid electrolyte, regardless of its shape. Preferably the above-mentioned foil or multiple foils are inserted into the anode region prior to the melting step. Because of the above-mentioned difference tin thermal expansion coefficient between metal plug and solid electrolyte, the melting and refreezing of the metal plug results in a very small annular gap between foil and solid electrolyte that further assists wicking of sodium and limiting the availability of liquid sodium for chemical reaction to form Na₂Sₓ in the event of solid electrolyte fracture. For a metal plug fabricated from aluminium the thermal expansion coefficient is 25×10⁻⁶° C.⁻¹. For beta alumina the thermal expansion coefficient is 7.5×10⁻⁶° C.⁻¹. On heating up to the melting temperature of ˜670° C., which may be carried out either as a separate process step or as part of the cell assembly process, for example during thermocompression bonding of the seal components, the aluminium plug melts and thereby conforms to the shape of the anode region with relatively little voidage. On cooldown to ambient temperature and subsequent heat up to the cell operating temperature of 300-350° C., the annular gap between aluminium plug and the solid electrolyte tube, foil lined as desired, will widen from zero to 0.2 mm in the case of a solid electrolyte cylindrical tube of internal diameter 30 mm. Such a gap is suitable for wicking purposes while at the same time greatly restricting sodium flow in the event of solid electrolyte fracture.

In the embodiment of the present invention for which the metal plug is melted and refrozen as described above, it is necessary to provide a feedpipe to allow sodium flow from the reservoir. This may be achieved by means of a steel insert consisting of a steel tube and a flange and one end. The flange allows location of the insert and helps to avoid contact between the fused metal and ceramic solid electrolyte, thereby avoiding possible blockage of sodium transport around the inside surface of the solid electrolyte tube at its closed end.

In order that the invention may be more readily understood specific embodiments thereof will now be described with reference to the accompanying drawings in which:

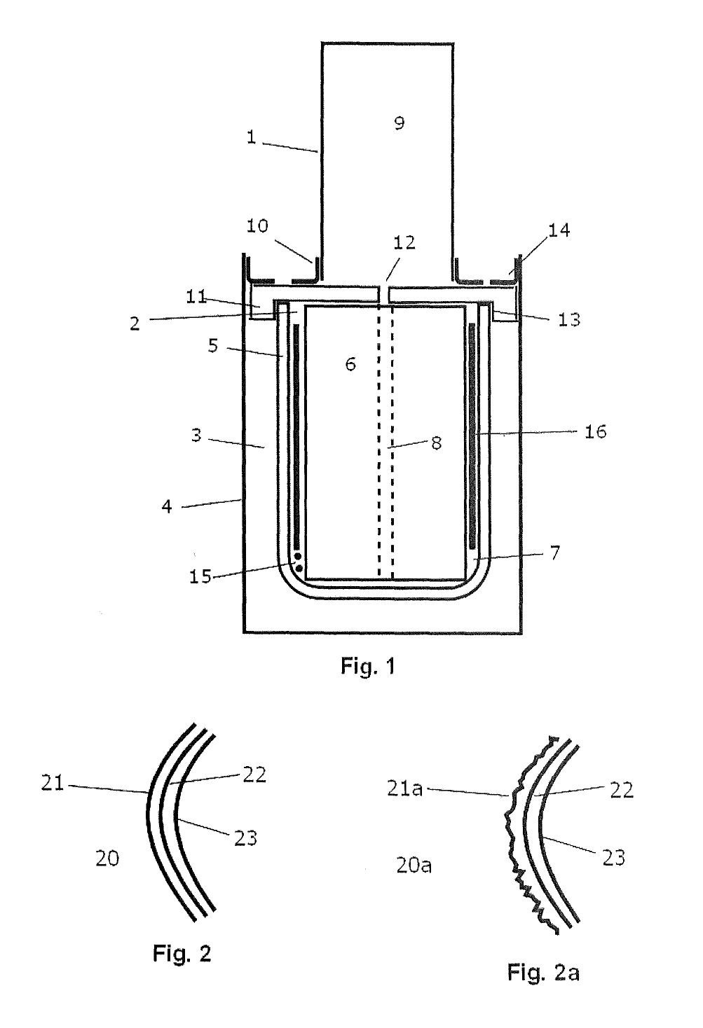

FIG. 1 shows diagrammatically, in longitudinal section, a NaS cell in accordance with a first embodiment of the invention;

FIG. 2 shows in radial section a multiple foil corresponding to the foil of the NaS cell of FIG. 1;

FIG. 2a shows in radial section a multiple foil in which the first foil has a rough surface or is of a corrugated form; and

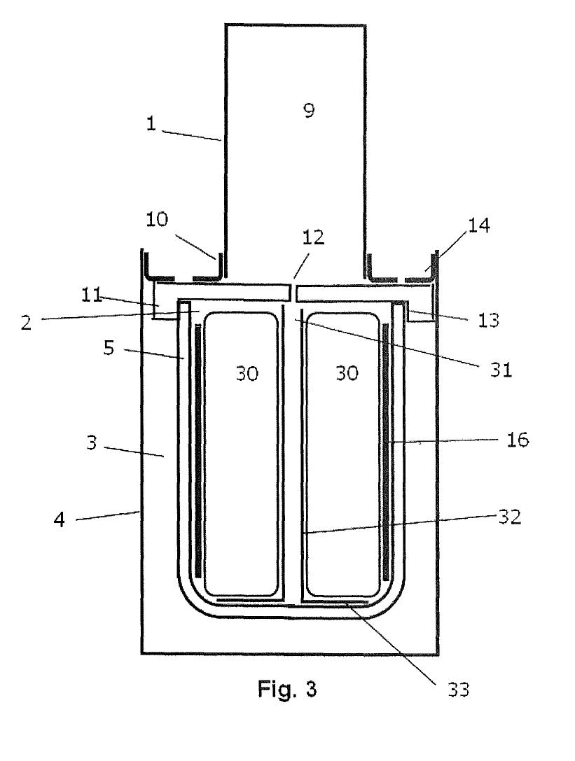

FIG. 3 shows diagrammatically, in longitudinal section, a NaS cell in accordance with a second embodiment of the invention.

Referring to the drawings, FIG. 1 shows a cross-section of a tubular NaS cell which includes an external reservoir 1 and an internal anode region 2. A cathode region 3 containing sulphur and Na₂Sₓ is contained within an external casing 4. A solid electrolyte tube 5 separates the cathodic reactant contained in cathode region 3 from the anode region 2 which contains liquid sodium. The internal volume of the solid electrolyte tube 5 defines the anode region 2 which is mostly filled with a metal plug 6 but leaves an annular gap 7 of approximately 1 mm between the plug 6 and the solid electrolyte tube 5. Hence the metal plug limits the amount of liquid sodium in the anode region in contact with the electrolyte tube 5. The metal plug optionally contains a central hole 8 to assist flow of liquid sodium between the anode region 2 and the external reservoir 1. When the cell is in the discharged state the external reservoir 1 is empty. On recharging the cell the external reservoir 1 becomes filled with liquid sodium 9. The external reservoir 1 is a metal container which is sealed hermetically via a flange 10 to an insulating ceramic plate 11 using bonding techniques as known in the art. The ceramic plate 11 may be fabricated from non-porous aluminium oxide and contains a central hole 12 to allow passage of liquid sodium. The plate 11 is joined to the solid electrolyte tube 5 by means of a glass seal 13 using bonding techniques as known in the art. The anode assembly is thereby hermetically sealed and can be filled with sodium under inert gas conditions or in vacuum. During cell assembly the anode region 2 and external reservoir 1 may be filled with liquid sodium under inert gas conditions prior to welding. An alternative method of assembling the cell is to form the welded joint between the flange 10 and ceramic plate 11 with the anode region 2 and external reservoir 1 empty and under vacuum, while the cathode region 3 is filled with Na₂Sₓ i.e. with the cell in the discharged state. On the first charge of the cell the anode region 2 and external reservoir 1 become filled with sodium by electrolytic ion transport through the solid electrolyte tube 5. The external casing 4 is hermetically bonded to the insulating ceramic plate 11 via the flange 14 using bonding techniques as known in the art.

To reduce the volume of sodium present in the vicinity of the solid electrolyte tube 5 the annular gap 7 may be filled with inert powder 15, for example zirconium silicate. It should be noted that even with infill powder present in the gap the amount of sodium available within the annulus for rapid chemical reaction in the event of solid electrolyte fracture may still be too large to avoid the risk of significant exothermic reaction. The interior surface of the solid electrolyte tube 5 is therefore covered with a springy single foil 16 or more preferably a multiple foil wick of thin metal foils 20 as shown in FIG. 2. The foil structure is of a thickness typically in the range 0.1 to 0.5 mm and forms a close fit with the electrolyte tube 5. The foil wick is preferably of nickel, which shows good wetting characteristics with liquid sodium. In the event of failure of the solid electrolyte tube 5, the presence of foil 16 helps to restrict the passage of liquid sodium through the cracks in the electrolyte tube 5 into the cathode region 4. In this way rapid chemical reaction between sodium and sulphur is hindered. The foil 16 has an additional advantage in that capillary flow of liquid sodium into the thin gap between the tube 5 and foil 16 promotes wetting of the ceramic surface by the sodium, thereby enhancing cell performance and reducing the potential for premature cell failure by poor wetting between solid electrolyte and liquid sodium, with consequent current concentration leading to possible solid electrolyte fracture. If desired foil 16 in its unwound state prior to assembly can be in the form of a corrugated sheet rather than a planar sheet.

FIG. 2 shows the detail of the multiple foil configuration 20 optionally used in FIG. 1. The first foil 21 is positioned adjacent to the solid electrolyte 5 and is fabricated preferably of nickel or other metal which exhibits good wetting with liquid sodium. The second foil 22 is included with the purpose of protecting the metal components inside the anode region 2 against corrosion by sodium polysulphide in the event of solid electrolyte fracture, and is preferably fabricated from grafoil sheet. The third foil 23 consists of a compliant ‘springy’ material, preferably stainless steel, which is tightly wrapped and springs outward when inserted into the anode. This assists in compressing the first and second foils 21, 22 against the solid electrolyte tube 5 ensuring a tight fit and small annular gap between the electrolyte tube 5 and foil 21.

FIG. 2a shows the detail of the multiple foil configuration 20a optionally used in FIG. 1, for which the first foil 21a positioned adjacent to the solid electrolyte 5 has a rough surface or is of a corrugated form which further improves wetting with liquid sodium.

FIG. 3 shows a further embodiment of the invention in which the metal plug 30 is melted and refrozen prior to cell operation. A steel insert 31 consists of a tube 32 that directs ingress of sodium from the external reservoir 1. The tube 32 is welded to an end flange 33 which assists location of the insert during assembly and directs the flow of sodium to the side walls of the solid electrolyte tube 5. In this embodiment of the invention the presence of infill powder 15 is not necessary, but a foil 16 or multiple foil 20 is used to prevent possible adherence of the molten metal plug 30 to the solid electrolyte tube 5.

It is to be understood that the above described embodiments are by way of illustration only. Many modifications and variations are possible.

1. An electrochemical cell comprising a cathodic reactant, an anodic region containing liquid sodium, and a solid electrolyte separating the cathodic reactant from the liquid sodium in the anodic region, the anodic region being contained within the solid electrolyte, the cell further comprising a separate reservoir of liquid sodium the anodic region being supplied with liquid sodium from the reservoir, wherein, a metal plug provided in the anodic region and said reservoir is not contained within the solid electrolyte.

2. A cell as claimed in claim 1, wherein the solid electrolyte is in tubular form.

3. A cell as claimed in claim 1, wherein the volume of the metal plug is more than 80% of the volume of space contained within the solid electrolyte.

4. A cell as claimed in claim 1, wherein the gap between the solid electrolyte and the metal plug is within the range from 0.1 to 1.0 mm.

5. A cell as claimed in claim 1, wherein the metal plug contains a hole through which liquid sodium may flow from the external reservoir.

6. A cell as claimed in claim 1, wherein the metal plug contains an insert, the insert comprising a feedpipe.

7. A cell as claimed in claim 1, wherein the metal plug is formed by melting in-situ.

8. A cell as claimed in claim 1, wherein the metal plug comprises aluminium.

9. A cell as claimed in claim 1, wherein the solid electrolyte is fabricated from at least one material in the group consisting of beta″-alumina, Nasicon, and beta″-alumina/zirconia composite.

10. A cell as claimed in claim 1, wherein the cathodic reactant consists of one or more materials from the group consisting of sulphur, sodium polysulphide, nickel chloride and iron chloride.

11. A cell as claimed in claim 1, wherein an inert powder is provided in the gap between the solid electrolyte and the metal plug.

12. A cell as claimed in claim 11, wherein the inert powder is zirconium silicate.

13. A cell as claimed in claim 1, wherein the anodic region induces a multiple foil structure between the metal plug and the solid electrolyte.

14. A cell as claimed in claim 13, wherein the number of foils in the multiple foil structure is in the range of one to three.

15. A cell as claimed in claim 14 wherein at least one of the foils has a rough surface, or is of a corrugated form.

16. A cell as claimed in claim 13, wherein the foils are fabricated from one or more materials in the group consisting of nickel, steel and carbon.

17. A cell as claimed in claim 14, wherein the foils are fabricated from one or more materials in the group consisting of nickel, steel and carbon.
